(19) United States
(12) Patent Application Publication
(10) Pub. No.: US 2025/0008900 A1
(43) Pub. Date: Jan. 9, 2025

(54) SYSTEMS AND METHODS FOR PROVIDING CART DRAINAGE FOR A MODULAR GROW TOWER

(71) Applicant: Tavaci Technologies LLC, Alpine, UT (US)

(72) Inventors: Sean R. Peterson, Payson, UT (US); Johndavid Tueller, Orem, UT (US); Todd Garrett Tueller, Alpine, UT (US); Ryan Joseph Crawford, Salem, UT (US)

(21) Appl. No.: 18/765,019

(22) Filed: Jul. 5, 2024

Related U.S. Application Data
(60) Provisional application No. 63/512,110, filed on Jul. 6, 2023.
(60) Provisional application No. 63/512,129, filed on Jul. 6, 2023.

(51) Int. Cl. A01G 31/06; A01G 9/24; A01G 27/00

(52) U.S. Cl. CPC A01G 31/06; A01G 9/247; A01G 27/003

(57) ABSTRACT

The present disclosure presents systems and related methods for providing drainage in an modular grow tower. One such method comprises supporting a quantity of crops on a plurality of carts, where each cart comprises a tray with perforations and fins sloped to direct water and/or nutrients towards the perforations; traversing the carts in a moving path from a top end to a bottom end of the grow tower; providing water and/or nutrients to the crops via a sustenance system comprising a watering component and a nutrient dosing component; collecting the water and/or nutrients draining through the plurality of perforations in the carts using a drainage system comprising a plurality of drainage troughs; and/or transporting the collected water and/or nutrients from the drainage troughs to a drainage pipe configured to carry the water and/or nutrients away from the grow tower.

### CROSS-REFERENCE TO RELATED APPLICATION

This application claims priority to co-pending U.S. provisional application entitled, “Systems and Methods for Providing Cart Drainage for an Assembly Line Grow Pod,” having application No. 63/512,110, filed Jul. 6, 2023, and U.S. provisional application entitled, “Systems and Methods for Providing a Modular Grow Pod,” having application No. 63/512,129, filed Jul. 6, 2023, each of which is entirely incorporated herein by reference.

### TECHNICAL FIELD

Embodiments described herein generally relate to systems and methods for providing cart drainage for a modular grow tower.

### BACKGROUND

While crop growth technologies have advanced over the years, there are still many problems in the farming and crop industry today. As an example, while technological advances have increased efficiency and production of various crops, many factors may affect a harvest, such as weather, disease, infestation, and the like. Additionally, while the United States currently has suitable farmland to adequately provide food for the U.S. population, other countries and future populations may not have enough farmland to provide the appropriate amount of food.

### SUMMARY

Embodiments of the present disclosure present systems and related methods for providing drainage in an modular grow tower. One such system comprises a plurality of body frames; a plurality of lift frames located at a first end and a second end of the modular grow tower, the plurality of body frames positioned between the plurality of lift frames; and/or a plurality of carts configured to traverse the modular grow tower in a moving path from a top end to a bottom end of the modular grow tower. In various embodiments, each of the plurality of carts comprises a tray configured to support a quantity of crops; a plurality of perforations positioned proximal to a first side and a second side of the cart, the perforations configured to allow passage of water and/or nutrients; and/or a plurality of fins sloped to direct the water and/or nutrients towards the plurality of perforations. The system may further include a sustenance system configured to provide water and/or nutrients to the crops supported by the plurality of carts as the carts traverse the modular grow tower; a drainage system comprising a plurality of drainage troughs configured to collect the water and/or nutrients which drain from the plurality of perforations in the plurality of carts; and/or a computing device configured to control the sustenance system and/or watering system in provisioning of nutrient and/or water amounts according to a grow recipe.

Embodiments of the present disclosure also include a method comprising supporting a quantity of crops on a plurality of carts, each cart comprising a tray with a plurality of perforations and a plurality of fins sloped to direct water and/or nutrients towards the plurality of perforations; traversing the plurality of carts in a moving path from a top end to a bottom end of the grow tower; providing water and/or nutrients to the crops via a sustenance system comprising a watering component and a nutrient dosing component, each configured to distribute water and/or nutrients to the crops at predetermined areas of the grow tower; collecting the water and/or nutrients draining through the plurality of perforations in the carts using a drainage system comprising a plurality of drainage troughs; and/or transporting the collected water and/or nutrients from the drainage troughs to a drainage pipe configured to carry the water and/or nutrients away from the grow tower.

Embodiments of the present disclosure also include a cart configured for draining excess water and/or nutrients in a grow tower, such that the cart includes a tray configured to support a quantity of crops; a plurality of perforations positioned proximal to a first side and a second side of the cart, the perforations configured to allow passage of water and/or nutrients; a plurality of fins sloped to direct the water and/or nutrients towards the plurality of perforations; and/or a plurality of wheels coupled to the tray for supporting the cart as it traverses the grow tower.

In one or more aspects for modular grow tower systems and related methods and apparatuses, the moving path comprises a serpentine moving path; the sustenance system comprises a watering component and a nutrient dosing component, each configured to distribute water and/or nutrients to the crops at predetermined areas of the modular grow tower; the watering component and the nutrient dosing component each comprise a plurality of nozzles mounted within the body frames to provide water and/or nutrients to the crops located within the carts; the watering component is coupled to one or more fluid lines which distribute water and/or nutrients to one or more trays at predetermined areas of the grow tower; the drainage troughs are configured to transport the collected water and/or nutrients to a drainage pipe configured to carry the water and/or nutrients away from the modular grow tower; the tray comprises foam-reinforced thermoformed plastic; and/or the tray is sloped such that water and/or nutrients received by the cart are directed to the plurality of perforations positioned proximal to the first and/or second sides of the cart.

In one or more aspects, such systems, methods, and/or apparatuses of the present disclosure can involve or comprise monitoring, by a processor, of water usage and consumption to determine an amount of water to apply to the crops at subsequent watering stations; and/or growing crops of multiple varieties.

Other systems, methods, features, and advantages of the present disclosure will be or become apparent to one with skill in the art upon examination of the following drawings and detailed description. It is intended that all such additional systems, methods, features, and advantages be included within this description and be within the scope of the present disclosure.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a modular grow tower according to one or more embodiments shown and described herein;

FIG. 2A depicts a sustenance system for providing water and/or nutrients to crops in the modular grow tower of FIG. 1 according to one or more embodiments described herein;

FIG. 2B depicts another sustenance system for providing water and/or nutrients to crops in the modular grow tower of FIG. 1 according to one or more embodiments described herein;

FIG. 3 depicts a perspective view of a cart for receiving crops or crop matter in the modular grow tower of FIG. 1 according to one or more embodiments shown and described herein;

FIG. 4 depicts a perspective view of a drainage component of the modular grow tower of FIG. 1 according to one or more embodiments described herein; and

FIG. 5 depicts a computing device for an exemplary modular grow tower according to one or more embodiments shown and described herein.

### DETAILED DESCRIPTION

Embodiments disclosed herein include systems and methods for providing cart drainage for a plurality of carts in a modular grow tower. The plurality of carts may be configured to support a quantity of crops. Crops may include traditional agricultural materials, for example, seeds, seedlings, plants, grasses, fully-grown crops, leafy crops, crop output, such as seeds, nuts, fruit, and/or the like. Crops may also include non-traditional materials, for example, microgreens, eggs, algae, insects, insect larvae, fungi, other kinds of organic material, and/or the like. The modular grow tower may include a sustenance system which may be configured to provide nutrients and/or water to the crops supported by the plurality of carts as the plurality of carts traverse the modular grow tower. At least one of the plurality of carts may include a plurality of perforations which may be configured to allow the nutrients and/or water provided by the sustenance system to drain from the plurality of carts. The modular grow tower may further include a drainage system that includes a plurality of drainage troughs which may be configured to collect the water and/or nutrients which drain from the plurality of perforations in the plurality of carts as the carts traverse the modular grow tower. The drainage troughs may transport the water and/or nutrients drained from the plurality of carts to a drainage pipe, which may be configured to carry the water and/or nutrients away from the modular grow tower.

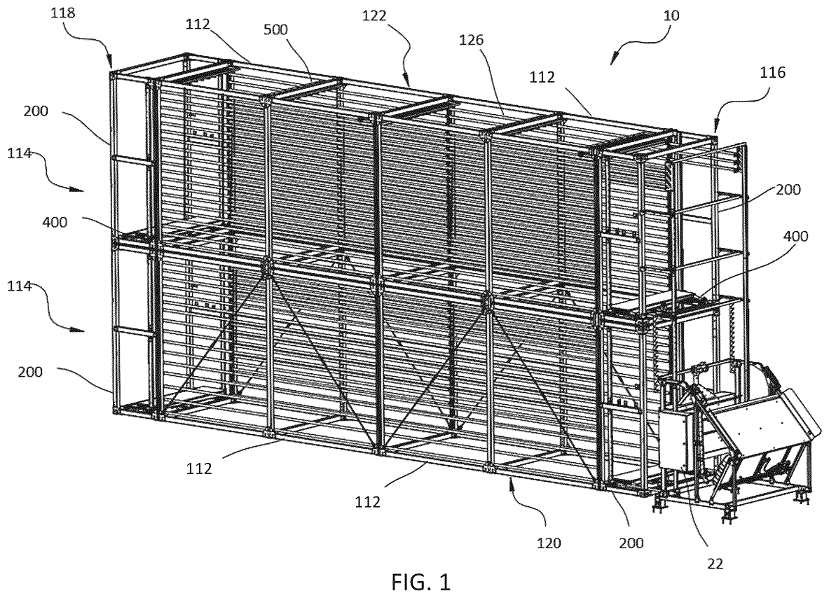

Referring initially to FIG. 1, a modular grow tower 10 is depicted. The modular grow tower 10 may comprise a plurality of body frames 112 and a plurality of lift frames 200. The plurality of lift frames may be located on a first end 116 and a second end 118 of the modular grow tower 10, and the plurality of body frames 112 may be positioned between the plurality of lift frames 200. As illustrated in FIG. 1, the plurality of lift frames 200 and body frames 112 may be stacked in a vertical direction such that the plurality of lift frames 200 and body frames 112 create a plurality of rows 114. Also depicted in FIG. 1 is a modular grow tower computing device 22, which may be configured for controlling various components of the modular grow tower 10.

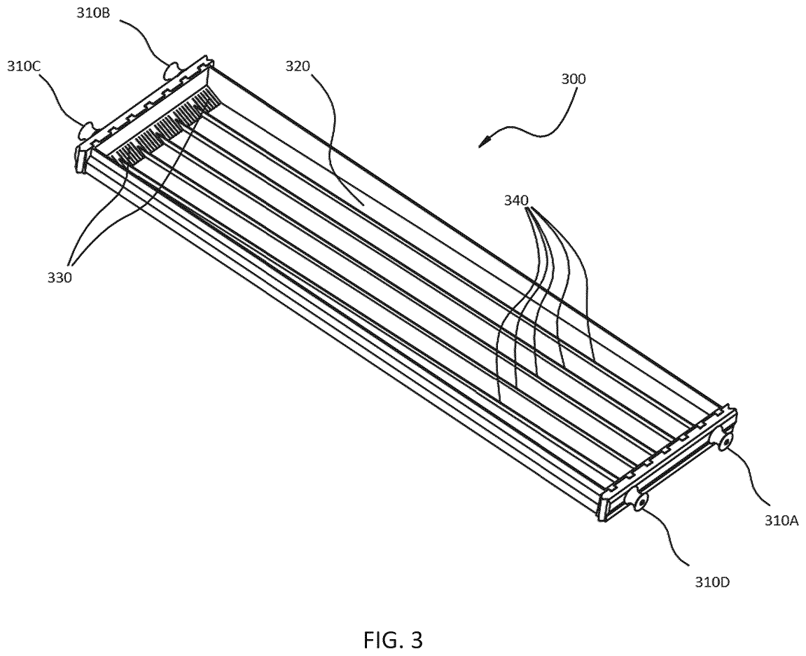

The plurality of body frames 112 may be configured to support a plurality of carts 300 (FIG. 3), which may traverse the modular grow tower 10 in a moving path (e.g., serpentine moving path, circular moving path, curved or straight moving path, etc.) from a top end 122 of the modular grow tower 10 to a bottom end 120 of the modular grow tower 10. The plurality of body frames 112 may further include a plurality of subframe supports 126, which may be configured to support the plurality of carts 300 such that the carts 300 may traverse the body frames 112 in a longitudinal direction. Once the carts 300 have traversed the length of the body frames 112, the lift frames 200 may further include a plurality of lift mechanisms 400, which may be configured to move the carts 300 in a vertical direction through the body frames 112.

In various embodiments, the modular grow tower assembly and constituent lift frames and body frames can comprises a variety of materials, such as, but not limited to, aluminum alloys, titanium alloys, carbon fiber reinforced polymer (CFRP), glass fiber reinforced polymer (GFRP), high-strength low-alloy (HSLA) steel, stainless steel, bamboo, composite materials (hybrid), engineered wood products (e.g., cross-laminated timber (CLT)), high-strength thermoplastics (e.g., polycarbonate, polyether ether ketone (PEEK)).

In various embodiments, the lift mechanisms 400 may be powered via pneumatic arms and/or motors, such as a plurality of translating mechanisms positioned along a length of a track, where each translating mechanism has a plurality of motorized apparatuses (e.g., motors) configured to push or pull the carts in a longitudinal direction. Correspondingly, the motorized apparatuses may be configured to push and retrieve the carts using extendable and retractable mechanical mechanisms to move the carts a predetermined length. In various embodiments, such motorized apparatus may be comprise one or more of motors, belts, chains, rollers, tracks, conveyers, rack and pinion gears, hydraulic systems, pneumatic systems, linear actuators, screw jacks, winches, cables and pulleys, gear systems, cam mechanisms, scissor lifts, and/or magnetic levitation systems.

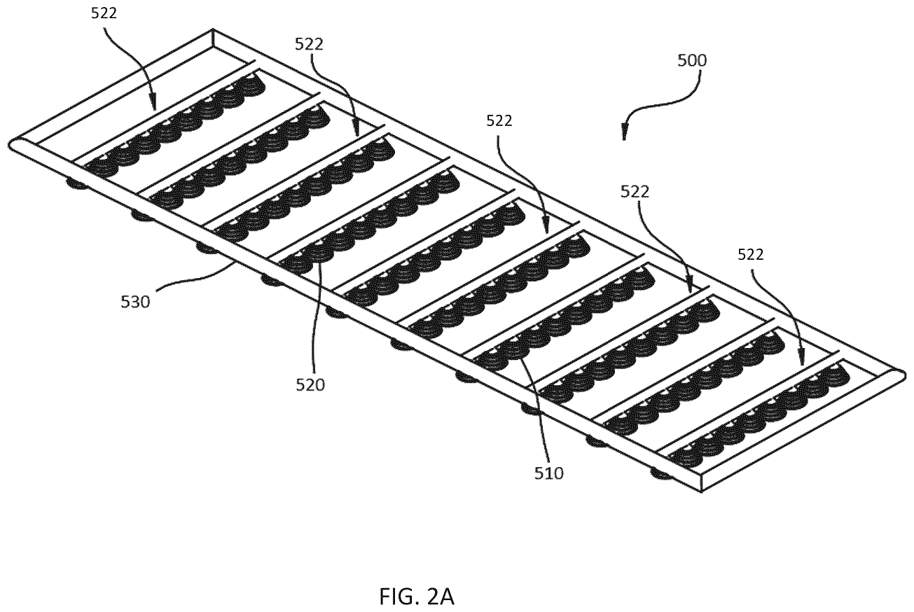

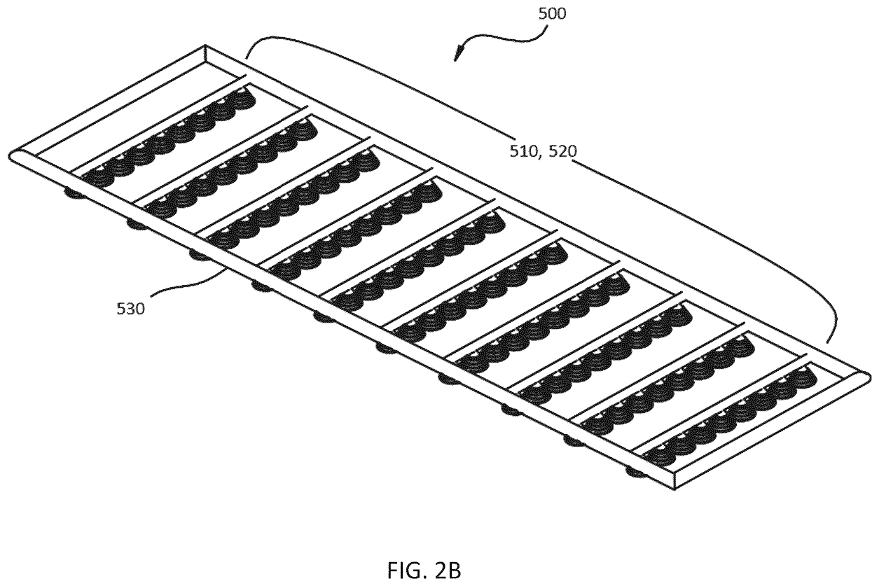

Referring now to FIGS. 2A and 2B, the modular grow tower 10 may further include a sustenance system 500. The sustenance system may provide nutrients and/or water to crops carried by the carts 300, as illustrated in FIGS. 2A and 2B. In some embodiments, the sustenance system 500 may include a watering component 510 and/or a nutrient dosing component 520. The watering component 510 and nutrient dosing component 520 may be configured to distribute water and/or nutrients to one or more trays of crops at predetermined areas of the modular grow tower 10. The watering component 510 and nutrient dosing component 520 may each comprise a plurality of spray nozzles 522, drip nozzles, flood nozzles, and/or other nozzles mounted within the body frames 112 to provide water and/or nutrients to the crops located within the carts 300. The nozzles 522 may be mounted within each of the body frames 112 or only certain body frames 112 within each row 114 of the modular grow tower 10. More particularly, the nozzles 522 may be mounted to the subframe supports 126.

In some embodiments, the watering component 510 may be coupled to one or more fluid lines 530, which distribute water and/or nutrients to one or more trays at predetermined areas of the modular grow tower 10. In some embodiments, crops may be sprayed with a fluid to reduce buoyancy and/or flooding. Additionally, water usage and consumption may be monitored, such that at subsequent watering stations, this data may be utilized to determine an amount of water to apply to the crops (or remove from a cell) at that time.

The nutrient dosing component 520 may provide at least a portion of the crops with a predetermined nutrient and/or dosage of nutrients. As discussed in more detail below, some embodiments may provide at least one watering component 510 that is distinct from the nutrient dosing component 520. In some embodiments, one or more of the nutrient dosing components 520 may be integral with one or more watering components 510 to provide a single station or mechanism for providing both water and nutrients (such as depicted in FIG. 2B).

Turning now to FIG. 3, a perspective view of the cart 300 is depicted. The cart 300 may include a tray 320, such as, but not limited to, a foam reinforced thermoformed tray, which may be configured to support a quantity of crops. A plurality of wheels 310A, 310B, 310C, and 310D may be coupled to the tray 320 for supporting the crops as the carts 300 traverse the moving path of the modular grow tower 10. In some embodiments, the plurality of wheels 310A, 310B, 310C, and 310D may be configured to engage with the plurality of subframe supports 126 of the body frames 112, such that the carts 300 are capable of traversing the supports 126 in a longitudinal direction.

In various embodiments, the moving path may take various shapes. For example, the moving path may comprise a serpentine path, such as one that starts from the top, moving trays horizontally in one direction, then down one sequential row as they reach the end of the horizontal path. The trays then move in the opposite horizontal direction along the new row, then down another row to continue the same pattern, and so forth. Alternatively, in various embodiments, the moving path may comprise a C-Shape path, such that carts may move horizontally in one direction on the top half of the total rows, then down to the bottom half of the total rows where the lighting system may be located. The carts may then move horizontally in the opposite direction, being harvested at the bottom. Correspondingly, in some embodiments, the moving path may comprise alternating rows/skipping rows path such that carts may move from row A to row C and then, subsequently, carts may move from row B to row D, instead of A to B to C to D in sequence. Further, in various embodiments, the moving path may having batching collections of rows such that groups of rows may be set and left without movement for many days and then all moved to a new set of rows with different heights or systems in one rapid succession. For example, rows A, B, C, and D may be batched to be moved on the same day to rows I, J, K, and L, while rows E, F, G, and H remain stationary until the following day. Additionally, in various embodiments, the moving path may comprise a haphazard path such that carts from the top rows can be moved down to any of the lower rows where different systems such as nutrients, lighting, watering, and measuring are located, and then moved back up again to the same row of origin or another row, offering full versatility.

Referring still to FIG. 3, the cart 300 may include a first side and a second side. In some embodiments, the plurality of carts 300 may include a plurality of perforations 330 positioned proximal to the first and/or second side of the cart 300. In some embodiments, the perforations 330 may be smaller than the size of the crops and/or crop matter received by the cart 300, but large enough to allow the passage of water. As the carts 300 traverse the serpentine moving path of the modular grow tower 10, roots from the crops received by the cart 300 may also grow within the plurality of perforations 330. However, the plurality of perforations 330 may be small enough to ensure that the roots which may grow within the plurality of perforations 330 do not become tangled.

The carts 300 may further comprise a plurality of fins 340. The plurality of fins 340 may be sloped such that water and/or nutrients received by the cart 300 from the sustenance system 500 is directed towards the plurality of perforations 330 positioned proximal to the first and/or second side of the cart 300. In some embodiments, the tray 320 may also be sloped such that water and/or nutrients received by the cart 300 are directed to the plurality of perforations positioned proximal to the first and/or second side of the cart 300 after interacting with the crops supported by the cart 300. As the carts 300 traverse the serpentine moving path of the modular grow tower 10, excess water and/or nutrients received by the carts 300 may drain from at least a portion of the plurality of perforations 330.

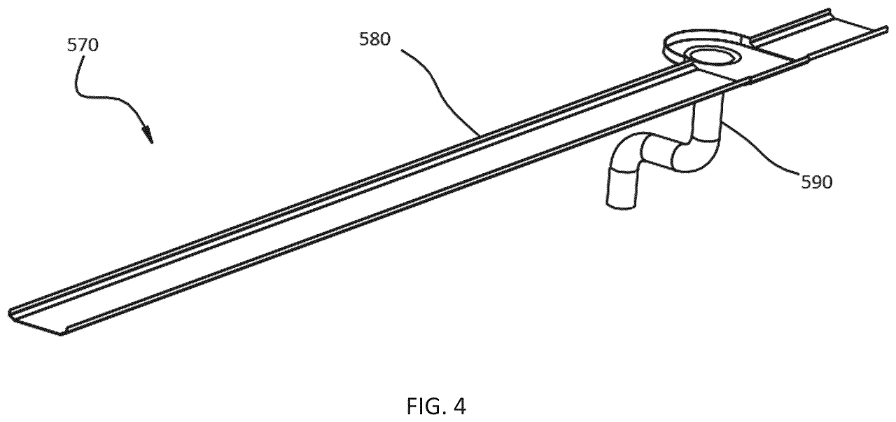

As further illustrated in FIG. 4, the modular grow tower 10 may include a drainage system 570, which may be configured to receive the excess water and/or nutrients which pass through at least a portion of the plurality of perforations 330 of the carts 300. The drainage component 570 may include a draining trough 580 and a drainage pipe 590. In practice, the drainage trough 580 may collect excess water and/or nutrients that pass through the plurality of perforations 330 of the carts 300. The drainage trough 580 may transport the excess water and/or nutrients to the drainage pipe 590, which may be configured to carry the excess water and/or nutrients away from the modular grow tower 10.

In various embodiments, the body frames 112 may have a plurality of drainage troughs 580 mounted to the subframe supports 126 of the body frames 112. In one embodiment, the drainage pipe 590 may be located outside the body frames 112, and may extend from a top end 122 to a bottom end 120 of the modular grow tower 10 in a substantially vertical direction. In this configuration, the draining pipe 590 may be configured to interact with the plurality of drainage troughs 580 located throughout the body frames 112. As excess water and/or nutrients are collected in the plurality of drainage troughs 580, gravity may act to carry the excess water and/or nutrients down through the drainage pipe 590, where the excess water and/or nutrients may be collected in a drainage bin. In some embodiments, the excess water and/or nutrients collected in the drainage bin may be recycled, reclaimed, and/or reused and reentered into the modular grow tower 10 via the watering component 510 and nutrient dosing component 520.

In receiving and draining water and/or nutrients from the substance system 500, a cart 300 may receive crops and enter the modular grow tower 10 by being placed on a subframe support 126 located a top end 122 and first end 116 of the modular grow tower 10. In one embodiment, the subframe support 126 may comprise at least one watering component 510 and at least one nutrient dosing component 520.

As the cart 300 moves in a longitudinal direction along the subframe support 126 towards the second end of 118 of the modular grow tower 10, the cart 300 may receive water and nutrients from the watering component 510 and nutrient dosing component 520, respectively. In some embodiments, the watering component 510 and the nutrient dosing component 520 may be positioned along the subframe support 126 such that the crops in the cart 300 receive water prior to receiving nutrients.

As the cart 300 passes under the watering component 510, the watering component 510 may be configured to provide water across the full length of the cart 300. Further still, the watering component 510 may be configured to provide a quantity of water to the cart 300 that is sufficient to fully submerge the crops secured on the cart 300. In some embodiments, the crops on the carts 300 may float in the tray 320 as water is provided to the cart 300. In these embodiments, the watering component 510 may be configured to mist the crops prior to providing water to submerge the crops. As the crops are misted, water may fall under the crops on the cart 300, such that the crops may stick to the tray 320 of the cart. Once the crops are secured to the tray 320, the watering component 510 may provide water to the cart which is sufficient to submerge the crops.

Once the crops are fully submerged, the plurality of fins 340 and the slope of the tray 320 of the cart 300 will force the water towards the plurality of perforations 330 positioned proximal to the first and second sides of the carts 300. As the water moves towards the plurality of perforations 330, water will begin to drain through the perforations 330. As the water drains through the perforations 330, the cart 300 may continue to traverse the subframe support 126 towards the second end 118 of the modular grow tower 10. Water may continuously drain from the cart 300 via the perforations 330 as the cart traverses the subframe support.

As the cart 300 continues to traverse the subframe support 126, the cart 300 may also receive nutrients from the nutrient dosing component 520. The nutrients provided to the crops on the cart 300 may mix with the water in the cart 300 such that both the water and nutrients may drain through the plurality of perforations 330 in the cart 300. As the water passes through the plurality of perforations 330 of the cart 300, the water may be collected by the drainage troughs 580 positioned on the subframe support beneath the cart 300. The excess water is carried by the drainage trough 580 to the drainage pipe 590, which carries the excess water away to a drainage bin. The excess water and nutrients collected in the drainage bin may then be reused by the sustenance system as the cart 300 continues to traverse the modular grow tower 10. In one embodiment, the cart 300 receives water and nutrients at multiple positions throughout the modular grow tower 10, with the plurality of perforations 330 of the cart 300 being configured to effectively drain the water and nutrients as the cart 300 traverse the modular grow tower 10.

As discussed previously, the motion of carts does not need to follow a serpentine path nor is it limited to one set sequence. One possible method of moving carts in a modular grow tower assembly may be alternating which row carts are moved to, in a non-sequential or non-serpentine path. This alternating method only moves carts when necessary, to designated new rows of the modular grow tower assembly, based on specific growing requirements such as crop height, row spacing, lighting elements, nutrient application systems, visual inspections, harvesting, and/or washing. This method optimizes the movement of carts by reducing the overall motion required and consequently minimizing wear on the carts and the need for an extensive motion system.

In various embodiments, the alternating rows method is controlled by a computer program executed by a processor or controller of the modular grow tower computing device that dictates the sequence of cart movements based on specific growing requirements. For instance, the system can start by moving a cart from the top row to row A, and in the next cycle, move another cart from the top row to row B. This sequence can be customized to suit various growing conditions, ensuring that carts are moved efficiently and only when necessary.

Such a method allows for grouping certain rows together and alternating the movement of these groups. For example, the system can alternate between moving carts in rows A, C, and E in one cycle and rows B, D, and F in the next cycle. Another possibility is moving carts from row A to C in one cycle, then only move carts from rows B to D in the next. Another possibility is moving carts from rows A, B, and C to the next level of rows D, E, and F or even to the bottom rows, for the sake of example could be labeled X, Y, and Z. This reduces the overall motion required during an entire grow cycle of a crop from start to finish, thereby lowering the wear on the carts and minimizing the demand on the lift mechanisms.

Another option, in various embodiments, is allowing different rows of carts to be consolidated together into one entirely new row, and another possibility is individual carts can alternately be sent to a different row during a movement cycle. This is particularly useful when rows are spaced at different heights, and therefore accommodate continually growing crops. Another possible benefit is minimizing the cost of lighting systems by only requiring lighting on one or two rows. There are many other reasons to justify providing flexibility of cart paths and allowing consolidating rows. Accordingly, alternating and shuffling carts and rows can be performed in a large variety of ways in accordance with the present disclosure.

In various embodiments, the non-sequential movement of the carts is controlled by a computer program executed by the processor, which dictates the cart movement sequence based on the specific growing requirements. This sequence can be customized in other variations to suit various growing conditions, grow times of different crops, reducing the frequency of cart movements and enhancing system efficiency. Correspondingly, a cart tracking system of sensors can allow the processor to keep track of the location of each cart and monitor the growing properties of the crops inside each cart. In various embodiments, the processor can also be configured to allow users to test and predict different patterns of cart movements to discover optimal cart pathways and patterns.

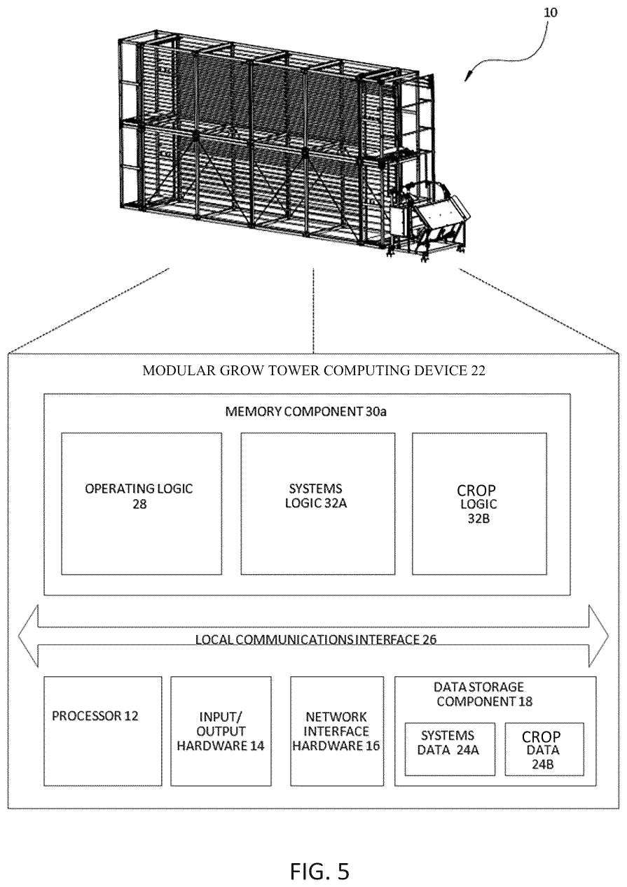

FIG. 5 illustrates a modular grow tower computing device 22, according to embodiments described herein. As discussed above, the modular grow tower computing device 22 includes a memory component 30a, a processor 12, input/output hardware 14, network interface hardware 16, and a data storage component 18 (which can store systems data 24A, crop data 24B, and/or other data). Each of the components of the modular grow tower computing device 22 may be communicatively coupled to a local communications interface 26. The local communications interface 26 is generally not limited by the present disclosure and may be implemented as a bus or other communications interface to facilitate communication among the components of the modular grow tower computing device (e.g., processor) coupled thereto.

The memory component 30a may be configured as volatile and/or nonvolatile memory and as such, may include random access memory (including SRAM, DRAM, and/or other types of RAM), flash memory, secure digital (SD) memory, registers, compact discs (CD), digital versatile discs (DVD), Blu-Ray discs, and/or other types of non-transitory computer-readable mediums. Depending on the particular embodiment, these non-transitory computer-readable mediums may reside within or outside the modular grow tower computing device 22. The memory component 30a may store, for example, operating logic 28, the systems logic 32A, and the crop logic 32B. The operating logic 28, the systems logic 32A and the crop logic 32B may each include a plurality of different pieces of logic, each of which may be embodied as a computer program, firmware, and/or hardware, as an example.

The operating logic 28 may include an operating system and/or other software for managing components of the modular grow tower computing device 22. As discussed above, the systems logic 32A and the crop logic 32B may reside in the memory component 30a and may be configured to perform the functionality, as described above. In some embodiments, the systems logic 32A and the crop logic 32B may reside on different computing devices. As an example, one or more of the functionalities and/or components described herein may be provided by a user computing device and/or remote computing device. While the modular grow tower computing device 22 is illustrated with the systems logic 32A and the crop logic 32B as separate logical components, this is only an example. In some embodiments, a single piece of logic (and/or several linked modules) may cause the modular grow tower computing device 22 to provide the described functionality.

The processor 12 may include any processing component operable to receive and execute instructions (such as from the data storage component 18 and/or the memory component 30a). Illustrative examples of the processor 12 include, but are not limited to, a computer processing unit (CPU), a many integrated core (MIC) processing device, an accelerated processing unit (APU), a digital signal processor (DSP). In some embodiments, the processor 12 may be a plurality of components that function together to provide processing capabilities, such as integrated circuits (including field programmable gate arrays (FPGA)) and the like.

In various embodiments, the modular grow tower computing device 22 or other component of the computing environment can monitor and measure sensor data, growth parameters, or other environmental factors, such as, but not limited to, temperature, humidity, light intensity, light duration, light spectrum, water quality/purity, water quantity, watering frequency, water temperature, water polarization, water flow rate, water filtration system efficiency, water mineral content, nutrient concentration, nutrient composition, pH level, airflow, CO₂ concentration, soil type, soil moisture, soil pH, soil composition, tray size and shape, tray material, growth medium, plant density, genetic factors, pollination, growth stage, harvest timing, microbial activity, oxygen levels, feeding frequency (for insects and larvae), substrate type (for fungus), light-dark cycles, movement frequency, sound vibrations, structural support (stakes, netting, cages, trellis, etc.), climatic conditions, altitude/barometric pressure, cleaning/washing/sanitizing/hygiene practices, growth hormones, symbiotic relationships if different crops are mixed, different crop or seed varieties in one tray, amount of human contact, pre-planting treatments or coatings applied to seeds, crop harvest weight, crop color, crop uniformity, crop density, crop level, nutrient content of crop harvests, and/or elemental analysis of crop harvests.

Additional factors that can be measured and/or used to customize tower operations include cart paths, cart maintenance reports, total electricity use, total water use, total seed or crop-starting material amount or weight, total time of carts in motion, total downtime of no motion, maintenance history, usage history, change history, video monitoring of individual systems, video monitoring of facility, user logs, software update history, bug reports, weather, and/or user notes.

The input/output hardware 14 may include and/or be configured to interface with microphones, speakers, a display, and/or other hardware. That is, the input/output hardware 14 may interface with hardware that provides a user interface or the like. The user interface may include a graphical user interface (GUI) comprising various interactive elements such as buttons, menus, display graphs, icons, sliders, and text fields. The GUI is designed to facilitate user interaction with the system, providing visual representations of data and controls to improve the overall usability and efficiency of the system. The graphical elements may be arranged in a layout that is intuitive and accessible, allowing users to navigate the interface and perform desired actions with ease.

The network interface hardware 16 may include and/or be configured for communicating with any wired or wireless networking hardware, including an antenna, a modem, LAN port, wireless fidelity (Wi-Fi) card, WiMax card, ZigBee card, Bluetooth chip, USB card, mobile communications hardware, and/or other hardware for communicating with other networks and/or devices. From this connection, communication may be facilitated between the modular grow tower computing device 22 and other computing devices, such as a user computing device, a remote computing device, and/or other devices.

The data storage component 18 may generally be any medium that stores digital data, such as, for example, a hard disk drive, a solid state drive (SSD), a compact disc (CD), a digital versatile disc (DVD), a Blu-Ray disc, and/or the like. It should be understood that the data storage component 18 may reside local to and/or remote from the modular grow tower computing device 22 and may be configured to store one or more pieces of data and selectively provide access to the one or more pieces of data.

It should be understood that while the components in FIG. 5 are illustrated as residing within the modular grow tower computing device 22, this is merely an example. In some embodiments, one or more of the components may reside external to the modular grow tower computing device 22. It should also be understood that, while the modular grow tower computing device 22 is illustrated as a single device, this is also merely an example. That is, the modular grow tower computing device 22 may represent a plurality of devices that are communicatively coupled to one another and provide the functionality described herein.

Additionally, while the modular grow tower computing device 22 is illustrated with the various logic components (e.g., the operating logic 28, the systems logic 32A, and the crop logic 32B) and data components (e.g., the systems data 24A and the crop data 24B) as separate components, this is also an example. In some embodiments, a single piece of logic (and/or a plurality of linked modules) and/or a single data component (and/or a plurality of linked modules) may also cause the modular grow tower computing device 22 to provide the functionality described herein.

Similarly, while the modular grow tower computing device 22 is depicted in a “PC” environment, it should be understood that at least some embodiments may not be limited in this way. Specifically, some embodiments may be configured such that the modular grow tower computing device 22 is configured as and/or includes a programmable logic controller (PLC) and/or other computing infrastructure.

While particular embodiments and aspects of the present disclosure have been illustrated and described herein, various other changes and modifications can be made without departing from the spirit and scope of the disclosure. Moreover, although various aspects have been described herein, such aspects need not be utilized in combination. Accordingly, it is therefore intended that the appended claims cover all such changes and modifications that are within the scope of the embodiments shown and described herein. It should also be understood that the embodiments described herein are merely exemplary and are not intended to limit the scope of this disclosure.

What is claimed is:

1. A system for draining a cart in an modular grow tower, comprising:
a plurality of body frames;
a plurality of lift frames located at a first end and a second end of the modular grow tower, the plurality of body frames positioned between the plurality of lift frames;
a plurality of carts configured to traverse the modular grow tower in a moving path from a top end to a bottom end of the modular grow tower, each of the plurality of carts comprising:
a tray configured to support a quantity of crops;
a plurality of perforations positioned proximal to a first side and a second side of the cart, the perforations configured to allow passage of water and/or nutrients; and
a plurality of fins sloped to direct the water and/or nutrients towards the plurality of perforations;
a sustenance system configured to provide water and/or nutrients to the crops supported by the plurality of carts as the carts traverse the modular grow tower;
a drainage system comprising a plurality of drainage troughs configured to collect the water and/or nutrients which drain from the plurality of perforations in the plurality of carts; and
a computing device configured to control the sustenance system and/or watering system in provisioning of nutrient and/or water amounts according to a grow recipe.

2. The system of claim 1, wherein the moving path comprises a serpentine moving path.

3. The system of claim 1, wherein the sustenance system comprises a watering component and a nutrient dosing component, each configured to distribute water and/or nutrients to the crops at predetermined areas of the modular grow tower.

4. The system of claim 3, wherein the watering component and the nutrient dosing component each comprise a plurality of nozzles mounted within the body frames to provide water and/or nutrients to the crops located within the carts.

5. The system of claim 4, wherein the watering component is coupled to one or more fluid lines which distribute water and/or nutrients to one or more trays at predetermined areas of the grow tower.

6. The system of claim 1, wherein the drainage troughs are configured to transport the collected water and/or nutrients to a drainage pipe configured to carry the water and/or nutrients away from the modular grow tower.

7. The system of claim 1, wherein the tray comprises foam-reinforced thermoformed plastic.

8. A method for providing drainage in an modular grow tower, comprising:
supporting a quantity of crops on a plurality of carts, each cart comprising a tray with a plurality of perforations and a plurality of fins sloped to direct water and/or nutrients towards the plurality of perforations;
traversing the plurality of carts in a moving path from a top end to a bottom end of the grow tower;
providing water and/or nutrients to the crops via a sustenance system comprising a watering component and a nutrient dosing component, each configured to distribute water and/or nutrients to the crops at predetermined areas of the grow tower;
collecting the water and/or nutrients draining through the plurality of perforations in the carts using a drainage system comprising a plurality of drainage troughs;
transporting the collected water and/or nutrients from the drainage troughs to a drainage pipe configured to carry the water and/or nutrients away from the grow tower.

9. The method of claim 8, wherein the moving path comprises a serpentine moving path.

10. The method of claim 8, further comprising monitoring, by a processor, of water usage and consumption to determine an amount of water to apply to the crops at subsequent watering stations.

11. The method of claim 8, wherein the watering component and the nutrient dosing component each comprise a plurality of nozzles mounted within body frames to provide water and/or nutrients to the crops located within the carts.

12. The method of claim 8, further comprising growing crops of multiple varieties.

13. A cart configured for draining excess water and/or nutrients in a grow tower, comprising:
a tray configured to support a quantity of crops;
a plurality of perforations positioned proximal to a first side and a second side of the cart, the perforations configured to allow passage of water and/or nutrients;
a plurality of fins sloped to direct the water and/or nutrients towards the plurality of perforations; and
a plurality of wheels coupled to the tray for supporting the cart as it traverses the grow tower.

14. The cart of claim 13, wherein the tray is sloped such that water and/or nutrients received by the cart are directed to the plurality of perforations positioned proximal to the first and/or second sides of the cart.

15. The cart of claim 13, wherein the tray comprises foam-reinforced thermoformed plastic.
